(19) United States
(12) Patent Application Publication
(10) Pub. No.: US 2007/0124410 A1
(43) Pub. Date: May 31, 2007

(54) Delivering Dicom Data

(75) Inventor: Robert Hofstetter, Carlton, Victoria (AU)

Correspondence Address: BIRCH STEWART KOLASCH & BIRCH, PO BOX 747, FALLS CHURCH, VA, 22040-0747, US

(73) Assignee: Intellirad Solutions Pty Ltd., East Hawthorn (AU)

(21) Appl. No.: 10/557,187

(22) PCT Filed: May 19, 2004
(86) PCT No.: PCT/AU04/00663

§ 371 Date: Jan. 3, 2007

(30) Foreign Application Priority Data
May 19, 2003 (AU) 2003902423

(51) Int. Cl. G06F 15/16

(52) U.S. Cl. 709/217

(57) ABSTRACT

An image and associated information provided in a Digital Imaging and Communications in Medicine (DICOM) dataset can be delivered to a web browser. The DICOM dataset is separated into image data and associated data. The image data is translated into an image file and the associated data in an associated file is described using a format which is understood by the web browser. The image file and associated file are transmitted over a communications network to the web browser and the web browser is then used to display the image and associated information from the image file and associated file respectively.

### FIELD OF THE INVENTION

This invention relates generally to medical imaging. In particular, it relates to transmission of Digital Imaging and Communications in Medicine (DICOM) images and information to a web browser.

### BACKGROUND TO THE INVENTION

Medical imaging has made a significant contribution to improvements in diagnosing and treating many injuries and illnesses. There are many different types of medical imaging available including X-ray imaging, magnetic resonance imaging, computerised tomography, ultrasonic scanning, endoscopic imaging and nuclear imaging. As medical imaging techniques are continuously improving and evolving, physicians are able to provide patients with more informed diagnoses and more effective treatments and recovery plans. Patients who require specialist advice are, in most cases, able to present a copy of their medical images at an appointment with the specialising physician. However, this may not be possible for patients in remote regions, depending on the availability of specialists in the area.

As communications technology has developed, it has now become possible to pass vast quantities of information including images and accompanying data from one location to another over communications networks such as telephone networks and dedicated high speed communications networks. This has improved access to medical services for patients in remote locations and provides remote medical staff with better support. In some cases it also facilitates sharing of medical information and images, where compatible communication platforms and protocols are used.

Devices used to create and store different types of medical images usually differ and devices that create digital records of the images often use different file formats and different protocols to compress and de-compress the image data. The Digital Imaging and Communications in Medicine (DICOM) standard was developed to meet the needs of users and manufacturers of medical imaging equipment for interconnection of devices on standard networks including the Internet. The DICOM standard was developed by a committee consisting of medical professionals, manufacturing companies, service organisations, trade associations, government agencies and other interested parties worldwide to create and maintain international standards for the communication of biomedical, diagnostic and therapeutic information particularly in relation to digital images and associated data. Consequently, DICOM has become the most common standard for receiving digital medical images such as scans from a hospital. A primary advantage of the DICOM standard is that a piece of medical equipment or software produced by one manufacturer can communicate with software or equipment produced by another. Therefore, DICOM image data can be utilised by any party with access to a DICOM compatible viewer.

Despite the advantages the DICOM standard provides, it still excludes a large number of potential recipients without access to DICOM viewers from viewing DICOM images and data.

The discussion of the background to the invention included herein including reference to documents, acts, materials, devices, articles and the like is intended to explain the context of the present invention. This is not to be taken as an admission or a suggestion that any of the material referred to was published, known or part of the common general knowledge in the area as at the priority date of any of the claims.

### SUMMARY OF THE INVENTION

According to a first aspect of the present invention, there is provided a method of delivering an image and associated information provided in a Digital Imaging and Communications in Medicine (DICOM) dataset to a web browser, the method including the steps of:

(a) separating the DICOM dataset into image data and associated data;

(b) translating the image data into an image file;

(c) describing the associated data in an associated file using a format which is understood by the web browser;

(d) transmitting the image file and associated file over a communications network to the web browser; and

(e) using the web browser to display the image and associated information from the image file and associated file respectively.

According to a second aspect of the present invention there is provided a method for accessing a Digital Imaging and Communications in Medicine (DICOM) dataset, having an image and associated information, from a DICOM device using a web browser including the following steps:

(a) using a web browser to make a DICOM dataset request;

(b) translating the request into a DICOM query;

(c) forwarding the DICOM query to the DICOM device;

(d) receiving the queried DICOM dataset and translating it for transmission to the web browser by:

(i) separating the DICOM dataset into image data and associated data;
(ii) translating the image data into an image file; and
(iii) translating the associated data into a web browser-compatible associated file;
   (e) transmitting the image file and the associated file to the web browser; and
   (f) using the web browser to reconstruct the image and associated data to re-create the image and associated information of the DICOM dataset.

According to a third aspect of the present invention there is provided a method for accessing a Digital Imaging and Communications in Medicine (DICOM) dataset from a DICOM device using a web browser including the following steps:

(a) using a web browser to make a DICOM dataset request;

(b) translating the request into a DICOM query;

(c) forwarding the DICOM query to the DICOM device;

(d) receiving the queried DICOM dataset and translating it into a web browser-compatible associated file;

(e) transmitting the associated file to the web browser, and

(f) using the web browser to re-create the DICOM dataset;

wherein the DICOM dataset is absent an image.

DICOM datasets which may be absent an image include datasets such as those which contain radiology reports. Such reports may contain results, structured reports, worklists, physiological waveforms or other information communicated in the DICOM protocol.

According to another aspect of the present invention, there is provided a method for transmitting a Digital Imaging and Communications in Medicine (DICOM) dataset, having an image and associated information, from a DICOM device to a web browser including the steps of:

(a) separating the DICOM dataset into image data and associated data;

(b) translating the image data into an image file;

(c) translating the associated data into a web browser-compatible associated file; and

(d) transmitting the image file and the associated file to the web browser;

wherein the image file and the associated file are reconstructable at the web browser to re-create image and associated information of the DICOM dataset.

According to yet another aspect of the present invention, there is provided a method for transmitting a Digital Imaging and Communications in Medicine (DICOM) dataset having associated information from a DICOM device to a web browser including the steps of:

(a) translating the associated information into a web browser-compatible associated file; and

(b) transmitting the associated file to the web browser,

wherein the DICOM dataset is absent an image and the associated file is reconstructable at the web browser to re-create the associated information of the DICOM dataset.

Preferably, the communications network is the Internet, although any other suitable communications network may be used. The image file may be any type of image file which is suitable for transmission over the communications network. Such image file types include Portable Network Graphics (PNG), Joint Photographic Experts Group (JPEG), graphic interchange format (GIF), tagged image file format (TIFF) and bit maps (BMP), portable pixmap file format (PPM), sun raster (RAS) and X Windows bitmaps (XBM).

Preferably, the associated data provides information relating to the image conveyed in the image data. This information may be collected before, during or after acquisition of the DICOM image. Accordingly, the information may relate to a patient, an injury or illness, an image scanning device or settings or any other relevant material. Preferably the associated file uses Hypertext Markup Language (HTML) or Extensible Markup Language (XML) to describe the associated data. However any other web browser-compatible language may be used.

Any suitable application protocol for delivering electronic content over a communications network such as the Internet may be used. However, it is preferable that the image and associated files are transmitted over the Internet using the Hypertext Transport Protocol (HTTP).

According to a further aspect of the present invention, there is provided a translation gateway for facilitating viewing of an image and associated information provided in a Digital Imaging and Communications in Medicine (DICOM) dataset using a web browser, the translation gateway being configured to:

(a) separate a DICOM dataset into an image dataset and associated data;

(b) translate the image data into an image file; and

(c) translate the associated data into a web-browser-compatible associated file.

According to still another aspect of the present invention, there is provided a translation gateway for facilitating viewing of data in a Digital Imaging and Communications in Medicine (DICOM) dataset using a web browser, the translation gateway being configured to:

(a) separate a DICOM dataset into an image dataset and associated data;

(b) translate the image data into an image file; and

(c) translate the associated data into a web-browser-compatible associated file;

wherein the translation gateway facilitates transmission of a DICOM dataset with or without an image.

Preferably, a translation gateway having all the functionality required to perform the necessary protocol management, translations and transmissions of DICOM data to the web browser is used. Accordingly, the gateway separates the DICOM dataset, translates the image data into an image file and describes the associated data using HTML, XML or other suitable language. The gateway also includes a web server for transmitting requested images information files to the web browser. Although it is to be understood that the gateway is also suitable for facilitating viewing of DICOM datasets which do not contain image data, such as radiology reports and other such reports.

In one embodiment of the invention, the DICOM dataset is stored in a repository forming part of the gateway. The content of the DICOM dataset is published by decoding and storing it in the gateway repository. In such an embodiment, an Internet web browser requests the image and information using HTTP. The DICOM dataset corresponding to the requested image and information is then retrieved from the repository, separated into image and associated data and translated into a web browser-suitable image file and associated HTML or XML file. It is then transmitted to the web browser in response to the request In another embodiment of the invention, the DICOM dataset is queried directly from a DICOM application entity. In such an embodiment, the web browser requests an image and information from the gateway web server. The gateway translates the request into a DICOM query and forwards the query to a DICOM application entity having a suitable Service Class Provider (SCP) such as a Query/Retrieve SCP or a Work List SCP. Once the DICOM application entity responds to the gateway's request by supplying the DICOM dataset, the DICOM image is decoded, separated, translated and delivered to the web browser using the method previously described.

Using the web browser to display the image and associated information enables any Internet user to view images and information that have been prepared according to the DICOM standard in a format which is consistent with the Internet and DICOM. End users are unaware of the translation performed on the DICOM dataset by the gateway and do not require a DICOM suite or viewer to view the image and information. Using the method of the invention, multiple web browser clients can simultaneously access DICOM datasets using the gateway and a single web browser can be used to access DICOM datasets originating from multiple DICOM sources.

### BRIEF DESCRIPTION OF THE DRAWINGS

The invention will now be described with reference the accompanying drawings. It is to be understood that the particularity of the drawings and the embodiments described does not supersede the generality of the preceding description of the invention.

FIG. 1 illustrates gateway architecture for an embodiment of the invention.

FIG. 2 illustrates a reference model illustrating layers of communication protocols employed in embodiments of the invention.

FIG. 3a illustrates data flow according to an embodiment of the invention wherein DICOM Datasets are stored in a gateway repository. FIG. 3b illustrates data flow according to an embodiment of the invention wherein DICOM datasets are only stored within a DICOM application entity.

FIG. 4 illustrates an interaction sequence for an embodiment of the invention in which a DICOM dataset is acquired from a DICOM source and stored in a gateway repository.

FIG. 5 illustrates an interaction sequence wherein DICOM datasets are retrieved from the gateway repository of FIG. 4 and provided to a web browser.

FIG. 6 illustrates an interaction sequence for an alternative embodiment of the invention in which a DICOM application entity is directly queried for retrieval of a DICOM dataset by a gateway, and in which the dataset is subsequently received by a web browser.

### DETAILED DESCRIPTION

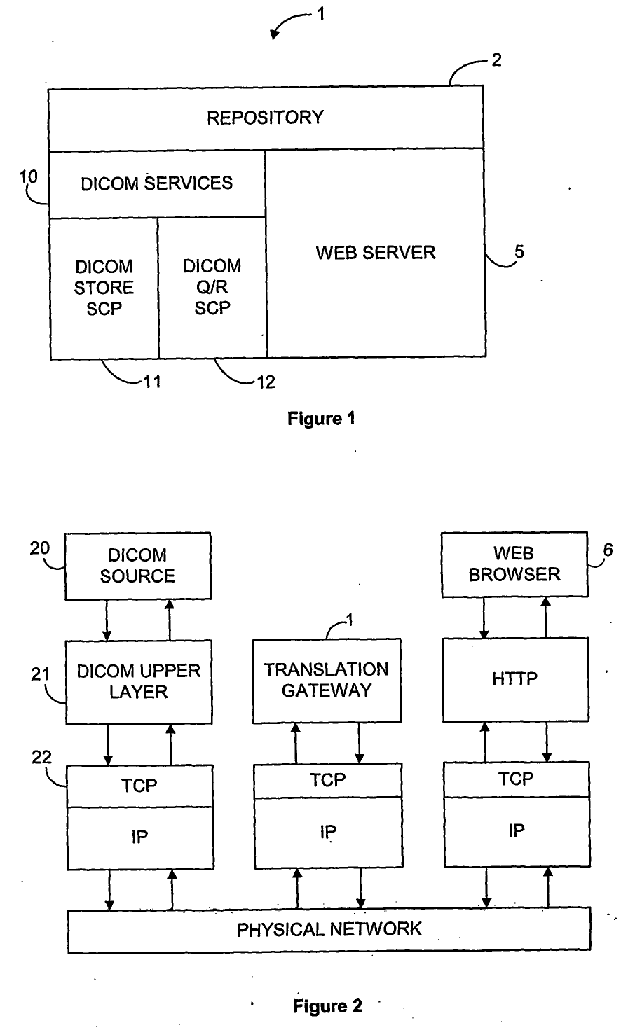

Referring firstly to FIG. 1, architecture for a translation gateway 1 is shown. Gateway 1 includes repository 2, web server 5 and DICOM services 10. DICOM services include DICOM Store Service Class Provider (SCP) 11 and DICOM Query/Receive (Q/R) SCP 12 which is responsible for managing DICOM communications, decoding DICOM datasets and storing them in repository 2. Web Server 5 is responsible for the presentation and delivery of information stored in repository 2 and for session management, while repository 2 is responsible for the storage, retrieval and management of DICOM datasets.

FIG. 2 shows communication protocol stacks for a DICOM source 20, a translation gateway 1 and a web browser 6. DICOM source 20 sends information using DICOM upper layer protocol 21 over the TCP/IP layer 22 to communicate with other DICOM compliant systems. Gateway Receive SCP 12 receives the DICOM datasets and stores them in repository 2. Gateway web server 5 then processes requests from web browser 6 and delivers the requested DICOM datasets using a standard image and HTML or XML file formats.

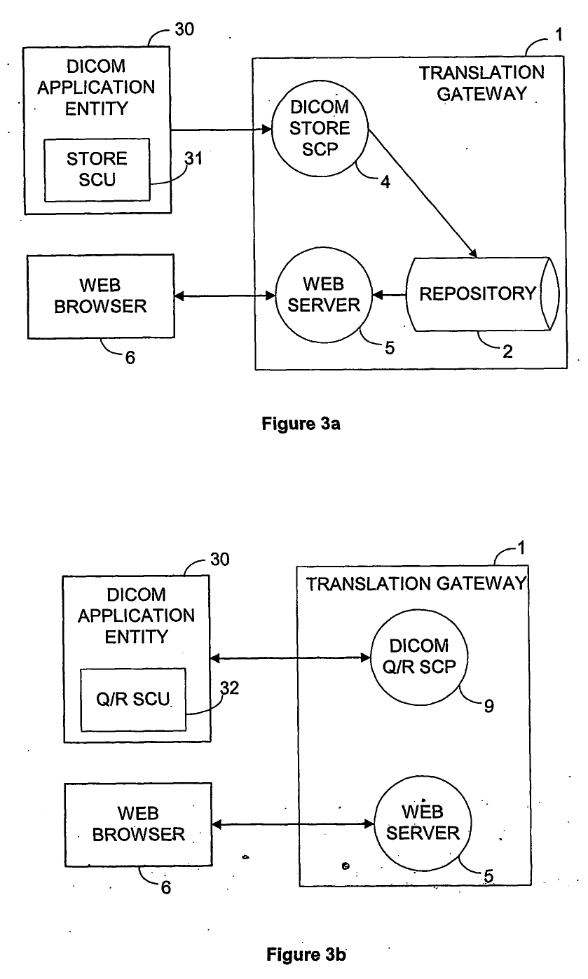

Referring now to FIG. 3a, information flow is shown according to an embodiment of the invention in which a plurality of DICOM datasets are stored in gateway repository 2 prior to being sent to web browser 6. Storage of DICOM datasets 7 in repository 2 occurs in an unsolicited fashion. A DICOM application entity 30 includes DICOM Store Service Class User (SCU) 31 which provides DICOM dataset 7 to a component of gateway 1 identified by reference numeral 4, which behaves like a DICOM SCP. Web browser 6 forms a request using the HTTP protocol to display the image and information provided in DICOM dataset.

The Hypertext Transport Protocol (HTTP) is a protocol which delivers electronic content over communications networks such as the Internet. HTTP delivers files which use web-browser-enabled languages such as Hypertext Markup Language (HTML), Extensible Markup Language (XML) and Extensible Hypertext Markup Language (XHTML). HTTP also delivers images in Portable Network Graphics (PNG), JPEG, bit maps, DIB, PPM, RAS, XBM and other suitable formats.

The web browser request is received and processed by gateway web server 5. Gateway 1 retrieves requested DICOM dataset 7 from repository 2 and separates and translates DICOM dataset 7, which contains a header and image data, into an image file and an associated data file. The header information may relate to a patient to whom the DICOM image belongs, the type of scan image and other relevant data and image data including image dimensions. The image file is translated to a web browser enabled image file format such as Portable Network Graphics (PNG), Joint Photographic Experts Group (JPEG), graphic interchange format (GIF), tagged image file format (TIFF), bit maps (BMP) portable pixmap file formats (PPM), sun raster (RAS) and X Windows bitmaps (XBM). The header information is described using HTML, XML or any other language suitable for interpretation by a web browser. Gateway 1 then delivers the requested image and information to web browser 6 in the form of standard image and HTML/XML files.

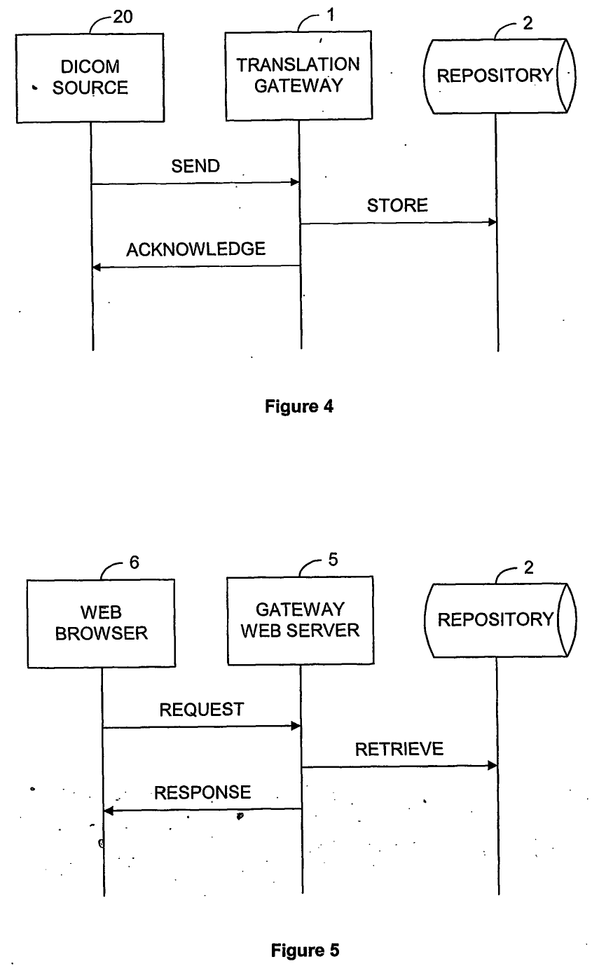

This process is also shown in the sequence diagrams of FIGS. 4 and 5. In FIG. 4, acquisition interactions between DICOM source 20 and translation gateway 1 are shown. DICOM source 20 sends a DICOM dataset to gateway 1 which publishes the dataset and stores it in gateway repository 2. Gateway 1 also acknowledges the transaction. FIG. 5 shows retrieval interactions in which web browser 6 requests an image from gateway web server 5. Web server 5 receives and processes the request. Gateway 1 then retrieves the requested DICOM data from repository 2 and responds to web browser 6 by sending the requested image and information PNG, JPEG, GIF, TIFF, BMP, DIB, PPM, RAS, TGA, XBM or other suitable image format and related information in HTML or XML or other web browser compatible format.

FIG. 3b shows information flow according to an embodiment of the invention in which DICOM datasets 7 are only stored within a DICOM application entity 30. Web browser 6 forms a request to display an image and information using the HTTP protocol. Gateway 1 translates the request into a DICOM query and forwards it to DICOM Query/Retrieve SCP 32 provided by DICOM application entity 30. DICOM Query/Receive SCP 32 responds to the query providing the requested DICOM dataset to translation gateway 1 which has a component identified by reference numeral 9 which behaves like a DICOM Query/Request SCU. Gateway 1 then separates DICOM dataset 7 into image data and associated data and translates these into a standard image file and an HTML or XML file respectively. The image and HTML/XML files are then transmitted by web server 5 to web browser 6 using the HTTP protocol. Upon delivery, the image and associated information are displayed by web browser 6.

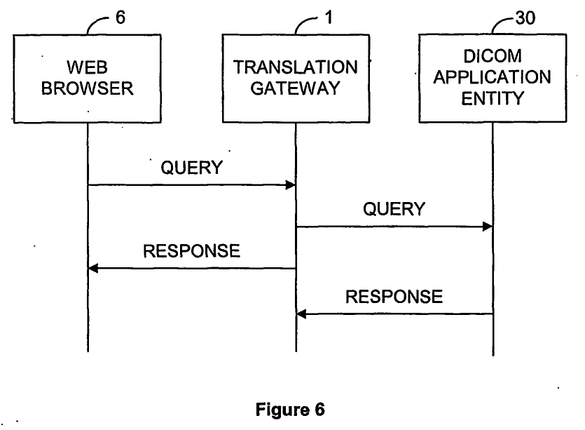

The sequence diagram of FIG. 6 illustrates interactions involved in the information flow illustrated in FIG. 3b in which translation gateway 1 forwards a query directly to a DICOM application entity 30. Here, web browser 6 requests a DICOM dataset from gateway 1. Gateway 1 translates the request and forwards it to DICOM application entity 30 which responds by providing the requested DICOM dataset to gateway 1. Gateway 1 separates and translates the DICOM dataset into a web browser-compatible image file and an associated HTML or XML file and responds to web server 6.

It is to be understood that the present invention is also applicable to DICOM datasets which do not contain image data, such as radiology reports and the like. Such reports may contain results, structured reports, worklists, physiological waveforms or other information communicated in the DICOM protocol.

The present invention facilitates practical, efficient and secure delivery of images provided in DICOM datasets to a web browser in an Internet environment. It allows medical images and related information to be transported from any DICOM source to a web browser anywhere in the world using the Internet. This provides an advantage over previous DICOM systems which limited viewing of DICOM images to users with access to specialised DICOM viewers or suites. As an added advantage, use of HTML and XML has the capacity to provide users with a configurable representation of DICOM images and information which can then be formatted to suit an end-user's specific requirements. Accordingly, the converted DICOM images can be represented using any web browser and stored/transmitted using any web browser-compatible extension. Additional algorithms can also be used to optimise transmission by compressing or otherwise augmenting files to suit available transmission bandwidth and delivery time.

As access to the Internet is widespread, most users have existing access to web browsers. Therefore, there is no need to manually install and maintain application software on user workstations as the information and data can be delivered over the web using existing and reliable web browsers and transmission protocols. This has the added benefit that users are able to work in an environment in which they are already familiar.

The present invention also enables a single web browser to provide a user with a seamless interface to data which originates from multiple DICOM application entities, and allows a single DICOM dataset to be accessed by multiple web browsers. It also provides a mechanism by which the contents of DICOM datasets may be accessed.

It is to be understood that various modifications, additions and/or deletions may be made to the parts previously described without departing from the ambit of the present invention.

1-24. (canceled)

25. A method for delivering an image and associated information provided in a Digital Imaging and Communications in Medicine (DICOM) dataset to a web browser, the method including the steps of:
(a) separating the DICOM dataset into image data and associated data;
(b) translating the image data into an image file;
(c) describing the associated data in an associated file using a format which is understood by the web browser;
(d) transmitting the image file and associated file over a communications network to the web browser; and
(e) using the web browser to display the image and associated information from the image file and associated file respectively.

26. A method for accessing a Digital Imaging and Communications in Medicine (DICOM) dataset, having an image and associated information, from a DICOM device using a web browser including the following steps:
(a) using a web browser to make a DICOM dataset request;
(b) translating the request into a DICOM query;
(c) forwarding the DICOM query to the DICOM device;
(d) receiving the queried DICOM dataset and translating it for transmission to the web browser by:
(i) separating the DICOM dataset into image data and associated data;
(ii) translating the image data into an image file; and
(iii) translating the associated data into a web browser-compatible associated file;
(e) transmitting the image file and the associated file to the web browser; and
(f) using the web browser to reconstruct the image and associated data to re-create the image and associated information of the DICOM dataset.

27. A method for accessing a Digital Imaging and Communications in Medicine (DICOM) dataset from a DICOM device using a web browser including the following steps:
(a) using a web browser to make a DICOM dataset request;
(b) translating the request into a DICOM query;
(c) forwarding the DICOM query to the DICOM device;
(d) receiving the queried DICOM dataset and translating it into a web browser-compatible associated file;
(e) transmitting the associated file to the web browser; and
(f) using the web browser to re-create the DICOM dataset;
wherein the DICOM dataset is absent an image.

28. A method for accessing a DICOM dataset according to claim 26 wherein steps (b) to (d) are performed by a translation gateway.

29. A method for accessing a DICOM dataset according to claim 27 wherein steps (b) to (d) are performed by a translation gateway.

30. A method for accessing a DICOM dataset according to claim 26 wherein the request is forwarded to a Service Class Provider (SCP) of the DICOM device including one or more of the following:
(a) a DICOM query/retrieve SCP; and
(b) a work list Service Class Provider (SCP).

31. A method for accessing a DICOM dataset according to claim 26 wherein the DICOM dataset is simultaneously accessible by a plurality of web browsers.

32. A method for accessing a DICOM dataset according to claim 25 wherein the associated file is in a format which includes one or more of the following formats:
(a) Hypertext Markup Language (HTML);
(b) Extensible Markup Language (XML); and
(c) Extensible Hypertext Markup Language (XHTML).

33. A method for accessing a DICOM dataset according to claim 28 wherein the image file is in a format including one or more of the following:
(a) joint photographic experts group (JPEG) file;
(b) graphic interchange format (GIF) file;
(c) bitmap (BMP);
(d) portable network graphic (PNG);
(e) tagged image file format (TIFF);
(f) portable pixmap file format (PPM);
(g) sun raster (RAS); and
(h) X Windows bitmaps (XBM).

34. A method for transmitting a Digital Imaging and Communications in Medicine (DICOM) dataset, having an image and associated information, from a DICOM device to a web browser including the steps of:
(a) separating the DICOM dataset into image data and associated data;
(b) translating the image data into an image file;
(c) translating the associated data into a web browser-compatible associated file; and
(d) transmitting the image file and the associated file to the web browser;
wherein the image file and the associated file are reconstructable at the web browser to re-create image and associated information of the DICOM dataset.

35. A method for transmitting a Digital Imaging and Communications in Medicine (DICOM) dataset having associated information from a DICOM device to a web browser including the steps of:
(a) translating the associated information into a web browser-compatible associated file; and
(b) transmitting the associated file to the web browser;
wherein the DICOM dataset is absent an image and the associated file is reconstructable at the web browser to re-create the associated information of the DICOM dataset.

36. A method for transmitting a DICOM dataset according to claim 34 wherein the DICOM dataset is first received at a translation gateway and the translation gateway performs steps (a) to (c).

37. A method for transmitting a DICOM dataset according to claim 34 wherein the DICOM dataset is simultaneously transmittable to a plurality of web browsers.

38. A method for transmitting a DICOM dataset according to claim 34 wherein the associated file is in a format which includes one or more of the following formats:
(a) Hypertext Markup Language (HTML);
(b) Extensible Markup Language (XML); and
(c) Extensible Hypertext Markup Language (XHTML).

39. A method for transmitting a DICOM dataset according to claim 36 wherein the image file is in a format including one or more of the following:
(a) joint photographic experts group (JPEG) file;
(b) graphic interchange format (GIF) file;
(c) bitmap (BMP);
(d) portable network graphic (PNG);
(e) tagged image file format (TIFF);
(f) portable pixmap file format (PPM);
(g) sun raster (RAS); and
(h) X Windows bitmaps (XBM).

40. A translation gateway for facilitating viewing of an image and associated information provided in a Digital Imaging and Communications in Medicine (DICOM) dataset using a web browser, the translation gateway being configured to:
(a) separate a DICOM dataset into an image dataset and associated data;
(b) translate the image data into an image file; and
(c) translate the associated data into a web-browser-compatible associated file.

41. A translation gateway for facilitating viewing of data in a Digital Imaging and Communications in Medicine (DICOM) dataset using a web browser, the translation gateway being configured to:
(a) separate a DICOM dataset into an image dataset and associated data;
(b) translate the image data into an image file; and
(c) translate the associated data into a web-browser-compatible associated file;
wherein the translation gateway facilitates transmission of a DICOM dataset with or without an image.

42. A translation gateway according to claim 40, further configured to receive from a web-browser a request for a DICOM dataset and translate the request into a DICOM query.

43. A translation gateway according to claim 40, further configured to forward the DICOM query to the DICOM device.

44. A translation gateway according to claim 40, further configured to receive from a DICOM device a DICOM dataset for delivery to a web browser.

45. A translation gateway according to claim 40 further including a web server for transmitting image files and associated files to the web browser.

46. A translation gateway according to claim 40 further including a repository for storing one or more DICOM datasets.

47. A translation gateway according to claim 40 embodied in a computer program product executable on a computer.
